(19) United States
(12) Patent Application Publication
(10) Pub. No.: US 2008/0103888 A1
(43) Pub. Date: May 1, 2008

(54) System and method for tracking purchases related to digital advertisements

(75) Inventor: Nick Weir, Phoenixville, PA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/588,047

(22) Filed: Oct. 26, 2006

(51) Int. Cl. G06Q 30/00

(52) U.S. Cl. 705/14

(57) ABSTRACT

A system and method for tracking purchases relating to digital ads is disclosed. Generally, an ad provider receives an ad request and determines whether a user requesting the ad is a registered user. In response to determining the user is a registered user, the ad provider determines whether any membership-based ads are available to serve to the user. When available, the ad provider serves at least one membership-based ad to the user. The user completes either an online or an offline transaction with a retailer that recognizes membership program members and, as appropriate, the retailer honors any offers associated with any membership-based ads served to the user. The ad provider sends ad campaign information associated with registered users to a data warehouse and the retailer sends transaction data associated with registered users to the data warehouse. The data warehouse grants limited access to the ad campaign and transaction information to advertisers and grants limited access to the transaction data to the ad provider.

### BACKGROUND

Marketers and retailers who advertise with online advertisement service providers such as Yahoo! Search Marketing often have trouble relating offline purchases to online advertisements. When a customer makes an offline purchase of an item or service, such as when a customer makes a purchase at a retail store or over the telephone, unless the customer informs a retailer that the customer is making the purchase after viewing an online advertisement, the retailer nor the item manufacturer does not know that an online advertisement is driving the purchase. Retailers and manufacturers desire a system and method that allows an online advertiser to track offline purchases, in addition to online purchases, after a customer views an advertisement so that online advertisers can measure the total effectiveness of their advertisement campaigns and improve the targeting and effectiveness of those campaigns over time.

### BRIEF DESCRIPTION OF THE DRAWINGS

FIG. 1 is a block diagram of one embodiment of an environment in which a system for tracking purchases related to digital advertisements may operate;

FIG. 2 is a block diagram of one embodiment of a system for tracking purchases related to digital advertisements; and

FIG. 3 is a flow diagram of one embodiment of a method for tracking purchases related to digital advertisements.

### DETAILED DESCRIPTION OF THE PREFERRED EMBODIMENTS

The present disclosure is directed to a system and method for tracking purchases related to digital advertisements (“digital ads”). The disclosed system allows online advertisement service providers (“ad providers”) and advertisers such as manufacturers or retailers to track both online and offline purchases of products and services related to digital ads. Tracking both online and offline purchases enables an advertiser to direct and optimize ad campaigns towards an appropriate segment of potential customers, or even specific users, and to measure a total return on marketing investments.

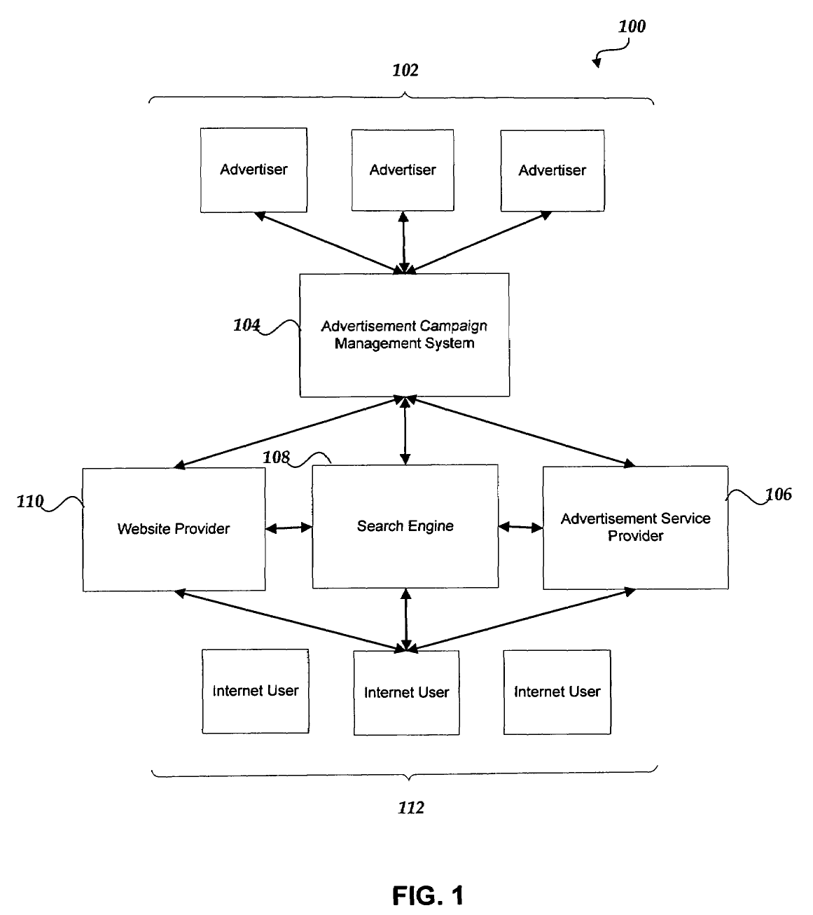

FIG. 1 is a block diagram of one embodiment of an environment in which a system for tracking purchases related to digital advertisements may operate. The environment 100 includes a plurality of advertisers 102, an advertisement campaign management system 104, an advertisement service provider 106, a search engine 108, a website provider 110, and a plurality of Internet users 112. Generally, an advertiser 102 creates an advertisement by interacting with the advertisement campaign management system 104. The advertisement may be a banner advertisement that appears on a website viewed by Internet users 112, an advertisement that is served to an Internet user 108 in response to a search performed at a search engine, or any other type of online advertisement known in the art.

When an Internet user 112 performs a search at a search engine 108, or views a website served by the website provider 110, the advertisement service provider 106 serves one or more advertisements created using the advertisement campaign management system 104 to the Internet user 112 based on search terms or keywords provided by the internet user or obtained from a website, or based upon a stored profile of that user or the machine in use. Additionally, the advertisement campaign management system 104 and advertisement service provider 106 typically record and process information associated with the served advertisement. For example, the advertisement campaign management system 104 and advertisement service provider 106 may record the search terms that caused the advertisement service provider 106 to serve the advertisement; whether the Internet user 112 clicked on a URL associated with the served advertisement; what additional advertisements the advertisement service provider 106 served with the advertisement; a rank or position of an advertisement when the Internet user 112 clicked on an advertisement; or whether an Internet user 112 clicked on a URL associated with a different advertisement. It will be appreciated that the disclosed system and method for tracking purchases related to digital advertisements described below may operate in the above-described environment.

Generally, the disclosed system and method for tracking purchases related to digital advertisements utilize a data warehouse that receives user profiles and digital ad information from an ad provider and user profiles and completed online and offline transaction information from retailers. The data warehouse provides the ad provider limited access to the transaction information and provides manufacturers and retailers (collectively “advertisers”) limited access to the ad provider information so that ad providers and advertisers can supplement their respective user profiles and determine the effectiveness of online ad campaigns as evidenced by transactions completed online at a website or offline over the telephone or at a retail store. Further, as an incentive to allow ad providers and advertisers to track customer purchases, the disclosed system and method provides customers special offers and discounts available only to those participating in the program.

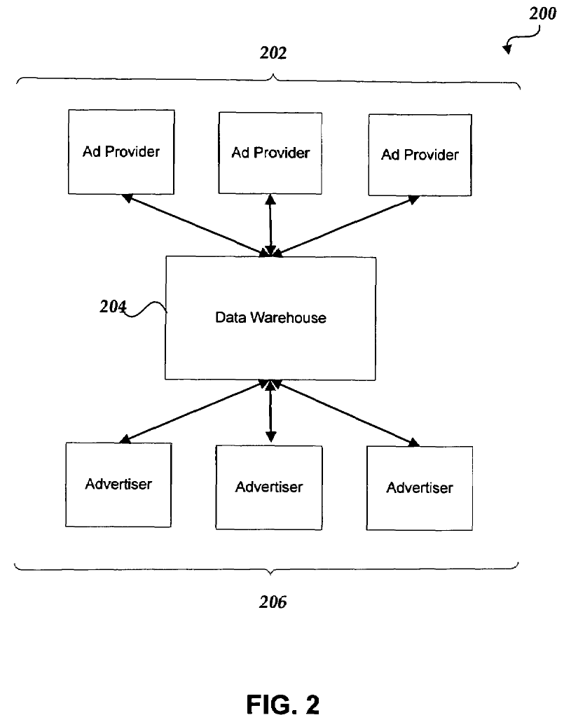

FIG. 2 is a block diagram of one embodiment of a system for tracking purchases related to digital ads. The system 200 typically includes one or more ad providers 202, one or more data warehouses 204, and one or more advertisers 206. The ad providers 202, data warehouses 204, and advertisers 206 typically communicate with each other over internal or external networks as known in the art, and may be implemented as software code running in conjunction with a processor such as a single server, a plurality of servers, or any other type of computing device known in the art.

Generally, each ad provider 202 includes a targeting platform 208 that enables the ad provider 202 to sell digital ads. The digital ads may be graphical ads, sponsored search listings, video ads, or any other form of digital marketing known in the art. Further, the digital ads may be normal digital ads that the ad provider 202 may serve to all users or membership-based ads that the ad provider 202 may serve to registered users only as explained in more detail below. Typically, the ad provider 202 will serve one or more graphical ads, video ads, or sponsored search listings when a user requests some form of digital content, such as a webpage or video on demand, or performs a search at a search engine as is known in the art.

One or more of the ad providers 202 may include a profile management tool 210. The profile management tool 210 allows a user to register with an ad provider 202 and to access and modify an ad provider user profile associated with the registered user. Typically, to register with an ad provider 202, a user will establish an account and provide demographic information to the ad provider 202 relating to the user. For example, a user may provide their age, sex, occupation, income level, residence, or any other type of demographic information that may be useful to an advertiser that is advertising with the ad provider 202. The user may additionally provide information to the ad provider 202 regarding one or more membership-based programs that the user participates in. For example, the user may provide the ad provider 202 with information regarding the user's membership with retailer loyalty programs, frequent flyer programs, credit card programs, grocery store club card programs, or any other type of membership-based programs, such as customer loyalty programs or otherwise. These types of information are examples of what may be stored in the profile management tool 210. In some implementations, the profile management tool 210 may additionally provide the user the ability to manage relationships with different manufacturers or retailers associated with the membership-based programs. For example, the user may be able to control what types of ads are received, how the ads are received, and how often ads are received.

During operation, a user may access a webpage or online video, or request a search that causes the ad provider 202 to serve digital ads to the user. When the ad provider 202 receives the request for digital ads, the ad provider 202 determines whether the user is a registered user, typically by examining a username, identification number, or email address received with the digital ad request. Such information may be compared against a list of registered users. If the user is not a registered user, the ad provider 202 serves one or more digital ads to the user as known in the art.

However, if the user is a registered user, the ad provider 202 determines whether, based upon the user's profile and the user's membership with any membership-based programs, the digital ad request may be met by serving one or more membership-based ads to the registered user that are not available to unregistered users. The membership-based ads may include special discounts, unique product/service offers, offers for limited edition products/services, access to restricted webpage areas associated with a retailer or manufacturer, or any other type of special offer a retailer/manufacturer may wish to offer users who participate in membership-based programs.

In some implementations, the special discounts in the membership-based ads are funded as a function of an increased return on investment of an advertiser while participating in the disclosed program. For example, the total value of the discounts and special offers of an advertiser participating in the disclosed method may be a function of a cost per acquisition (CPA) that an advertiser pays before entering the program and the improvement in return on investment (ROI) achieved through participating in the program, calculated in one embodiment using the equation:

D=CPA₁*(RPC+CPA₂−ROI),

where D is the value of discounts and offers; CPA₁ is the cost per acquisition before entering the program; RPC is the total measured revenue per customer due to offline and online conversions; CPA₂ is the percent decrease in cost per acquisition due to targeting; and ROI is the percent desired increase in return on marketing investment.

Before, after, or while serving ads to the registered user, the ad provider 202 may record ad campaign information associated with the served digital ads and associate the ad campaign information with the ad provider user profile of the user. For example, the ad provider 202 may record which ads were served, the position of any graphical ads in a webpage, the order of any sponsored search listings, which keywords caused the digital ads to be served, which digital ads the user click on, or any other type of information desired by the ad provider 202. The ad provider 202 sends at least a portion of the ad provider user profile and associated ad campaign information to the one or more data warehouses 204 for limited access by one or more advertisers 206 as explained below.

In some implementations, data for all ad providers 202 and all advertisers 204 are sent to a single data warehouse 204. However, in other implementations, the disclosed system and method may implement multiple data warehouses 204. For example, to ensure that information associated with a first membership-based program and a second membership-based program is not mixed at any time, all information associated with the first membership-based program may be sent to a first data warehouse and all information associated with the second membership-based program may be sent to a second data warehouse.

After receiving the digital ads from the ad provider 202, the user may initiate a transaction with a retailer to purchase a product or service. The transaction may occur online such as through a webpage, or may occur offline such as over the telephone or in a retail store. When the transaction is initiated, the retailer identifies the user as a registered user participating in the membership-based programs honored by that retailer, so that the retailer may honor the offers in the membership-based ads. To identify the user in online and offline transactions, the retailer may identify the user by comparing information such as a username, identification number, e-mail address, credit card number, telephone number, or any other means known in the art, against a list of registered users.

Before, after, or during the transaction, transaction data associated with the transaction is associated with a transaction user profile associated with the user. For example, the retailer may record transaction data such as the products/services purchased, the quantity of products/services purchased, the payment method for the transaction, and the location of where the products/services were purchased.

Similar to when a user registers with an ad provider 202, a user may additionally register with a manufacturer or retailer 206 to become part of a membership-based program of the manufacturer or retailer, resulting in the creation of a transaction user profile. The transaction user profile may be created directly with the manufacturer or retailer 206, or the transaction user profile may be created with the manufacturer or retailer 206 using the profile management tool 210 of the ad provider 202. As part of registering with the manufacturer or retailer 206, the user may provide demographic information to the manufacturer or retailer 206 such as the age, sex, occupation, income level, or residence of the user, or any other type of demographic information that may be useful to a manufacturer or retailer. The retailer 206 provides at least a portion of the transaction user profile and transaction data for completed transactions to the one or more data warehouses 204 for limited access by the ad provider 202 as described below.

In addition to when a user initiates a transaction driven by a digital ad from the ad provider 202, when a user initiates a transaction that is not driven by a digital ad, a retailer 206 may identify a user as a registered user as described above, associate transaction information with a transaction user profile associated with the user, and provide at least a portion of the transaction user profile and transaction data for completed transactions to the one or more data warehouse 204 for limited access by the ad provider 202 as described below. In other words, a retailer 206 may identify registered users and record transaction information associated with a transaction regardless of whether the transaction is driven by a digital ad to provide a more complete profile of a registered user.

The data warehouse 204 stores the ad provider user profile, transaction user profile, ad campaign information, and transaction data. Information relating to a single user is associated at the data warehouse 204, typically through the use of a common user name, e-mail address, or identification number. The data warehouse 204 grants the ad provider 202 limited access to the data provided by the advertisers 206 and grants the advertisers 206 limited access to the data provided by the ad provider 202. Typically, the ad provider 202 and advertisers 206 are given limited access to the data at the data warehouse 204 so that the ad provider 202 may supplement the ad provider user profile and the advertisers 206 may supplement the transaction profile, while still allowing the ad provider 202 and advertiser 206 to protect sensitive information that the ad provider 202 and/or advertisers 206 may not want to disclose to others, such as competitors, or even to each other. For example, in order to report on an advertising campaign's effectiveness at an aggregate level, it may be necessary to relate detailed transaction data at the individual product level with ad campaign information at the individual user level. While a retailer may be comfortable reporting such campaign effectiveness information to manufacturers and other advertisers at an aggregate level, it may not wish to share the detailed transaction data with them or with the ad provider. Likewise, while a retail advertiser may not allow an ad provider to supplement the ad provider user profile with transaction data at the individual product level, it may allow the ad provider to supplement its user profiles based upon purchasing behavior at the aggregate level. Similarly, an ad provider may not wish to share its user profile data at the individual user level with any advertiser, although it may allow advertisers to measure their campaigns' effectiveness broken down by aggregate user segments defined by those profiles.

By supplementing the ad provider user profile and transaction user profile, both the ad provider 202 and advertiser 206 are able to generate more detailed user profiles so that digital ads can be better targeted to potential customers. Additionally, supplementing the ad provider user profile and transaction user profile allows both the ad provider 202 and the advertiser 206 to generate more complete reports detailing when online ad campaigns results in sales of products and services, either through online purchases at a website or offline purchases over the telephone or at a retail store. Detailed reports regarding both online and offline transactions that occur after a customer views digital ads provide a useful tool for retailers and manufacturers to measure the effectiveness of a marketing campaign. Further, the detailed reports provide manufacturers who do not sell products themselves, a tool to measure the effectiveness of a marketing campaign across all retailers who participate in the disclosed program.

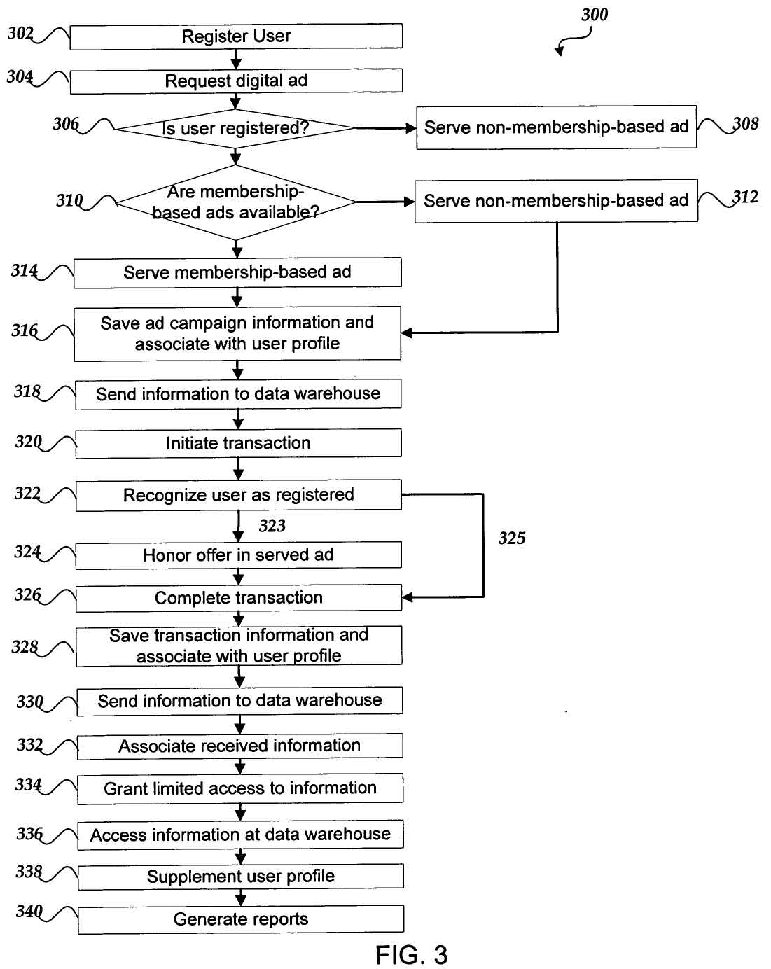

FIG. 3 is a flow diagram of one embodiment of a method for tracking purchases related to digital ads. The method begins with a user registering with an ad provider and a retailer and/or manufacturer (collectively “advertisers”) at step 302. It will be appreciated that the user may register with the ad provider and the advertisers separately at different times or the user may register with the ad provider and the advertisers at the same time. As part of registering, the user may create and modify a user profile associated with the ad provider and/or the advertiser that includes various types of demographic information and membership-based programs.

The user performs an action that causes an ad provider to serve a digital ad at step 304. To cause the ad provider to serve a digital ad, the user may perform actions such as requesting a webpage that includes one or more graphical ads, requesting online video content that includes one or more video ads, or the user may perform a search at a search engine that will return one or more sponsored search listings.

The ad provider determines whether the user is a registered user at step 306. The ad provider may determine the user is a registered user based on a username, identification number, or an email address received with the digital ad request, or by any other means known in the art. If the ad provider determines the user is not a registered user, the ad provider serves the user one or more digital ads that are available to both registered and unregistered users at step 308 and the method end. If the ad provider determines the user is a registered user, the ad provider determines whether any membership-based ads are eligible to serve to the registered user based on, for example, the demographic information, behavioral profile information, and/or membership-based programs associated with the user profile of the user at step 310.

If the ad provider determines membership-based ads are not available for the digital ad request, the ad provider serves one or more digital ads that are available to both unregistered and registered users at step 312. If the ad provider determines membership-based ads are available for the digital ad request, the ad provider may serve one or more membership-based ads available to only registered users and/or serve one or more digital ads that are available to both unregistered and registered users at step 314.

The ad provider saves ad campaign data associated with the ads served at step 312 or step 314 and associates the ad campaign data with the ad provider user profile of the registered user at step 316. The ad provider sends at least a portion of the ad provider user profile and ad campaign data associated with the ad provider user profile to one or more data warehouses at step 318.

After viewing the digital ads, or independent of any viewed digital ads, the user initiates a transaction to purchase a good or service at step 320. It will be appreciated that the user may initiate an online purchase through a website or may initiate an offline purchase over the telephone or at a retail store. A retailer recognizes the user as a registered user at step 322. If the user is initiating the transaction after viewing digital ads (323), the retailer may allow the user to redeem any offers provided in the served ads such as special offers in the membership-based ads at step 324 before completing the transaction at step 326. However, if the user is initiating the transaction independent of any viewed digital ads (325), the method proceeds to step 326 where the transaction is completed.

The retailer saves transaction information associated with the completed transaction and associates the transaction data with the transaction user profile at step 328. The retailer sends at least a portion of the transaction user profile and associated transaction data to one or more data warehouses at step 330.

The data warehouses associate the ad provider user profile and ad campaign information with the transaction user profile and transaction data at step 332. In one implementation, the data is associated based on a common username, e-mail address, or identification number. The data warehouse grants the ad provider and advertisers limited access to the associated data at step 334.

Either the ad provider or the advertisers may access the one or more data warehouses at step 336 and obtain a portion of the associated data to supplement the ad provider user profile or transaction user profile at step 338. Additionally, either the ad provider or the advertisers may generate reports indicating a relationship between served digital ads, user profile segments, and resulting sales that were transacted both online and offline at step 340. It will be appreciated that the above-described method is repeating for each transaction a registered user completes and for each new registered user.

FIGS. 1-3 describe a system and method for tracking purchases related to digital ads. The disclosed system allows ad providers and advertisers such as manufactures and retailers to track both online and offline purchases to enable advertisers to measure a total return on marketing investments and to optimize ad campaigns towards appropriate segments of potential customers. Generally, the disclosed system and method utilize one or more data warehouses to receive information from the ad providers and advertisers, and to provide limited access to the received information to the ad providers and advertisers to supplement user profiles associated with registered users and to generate reports regarding online and offline purchases after viewing digital ads. Further, as an incentive to participate in the program, users are provided special offers or discounts that are only available to registered users.

It is therefore intended that the foregoing detailed description be regarded as illustrative rather than limiting, and that it be understood that it is the following claims, including all equivalents, that are intended to define the spirit and scope of this invention.

1. A method for tracking purchases related to digital ads, the method comprising the steps of:
receiving a digital ad request;
determining whether a digital ad will be served to a registered user;
determining whether a membership-based ad is available to serve to the registered user in response to determining the digital ad will be served to a registered user;
serving one or more membership-based ads to the registered user; and
sending at least ad campaign information associated with at least the one or more served membership-based ads to a data warehouse.

2. The method of claim 1, further comprising:
updating a user profile associated with the registered user based on at least the one or more served membership-based ads; and
sending at least a portion of the user profile to the data warehouse.

3. The method of claim 2, further comprising:
retrieving transaction information associated with the registered user from the data warehouse; and
updating the user profile associated with the registered user based on the retrieved transaction information.

4. The method of claim 3, further comprising:
generating a report based on the user profile regarding transactions completed after viewing at least the one or more served membership-based ads.

5. The method of claim 1, wherein the digital ad is one of a graphical ad, a video ad, or a sponsored search listing.

6-7. (canceled)

8. The method of claim 1, wherein it is determined whether the digital ad will be served to a registered user based on at least one of a username, an identification number, and an e-mail address of a user.

9. The method of claim 1, wherein it is determined whether a membership-based ad is available to serve to the registered user based on a user profile of the user.

10. The method of claim 9, wherein the user profile comprises demographic information, behavioral information, and information regarding the registered users affiliation with at least one membership-based program.

11. The method of claim 1, further comprising:
receiving at least ad campaign information associated with at least the one or more served membership-based ads from an ad provider;
receiving transaction data associated with at least the registered user from a retailer;
granting limited access to the received ad campaign information to the retailer; and
granting limited access to the received transaction data to the ad provider.

12. The method of claim 11, further comprising:
granting limited access to the received ad campaign information to one or more advertisers.

13. The method of claim 11, further comprising:
detecting a user initiating a transaction is a registered user;
honoring an offer presented to the registered user in a membership-based ad;
completing a transaction regarding the offer presented to the registered user in the membership-based ad; and
sending transaction data associated with the membership-based ad to the data warehouse.

14. The method of claim 11, further comprising;
detecting a user initiating a transaction is a registered user;
completing the initiated transaction; and
sending transaction data associated with the completed transaction to the data warehouse.

15. A computer-readable storage medium comprising a set of instructions for tracking purchases related to digital ads, the set of instructions to direct a processor to perform acts of:
receiving a digital ad request;
determining whether a digital ad will be served to a registered user;
determining whether a membership-based ad is available to serve to the registered user in response to determining the digital ad will be served to a registered user;
serving one or more membership-based ads to the registered user;
sending at least ad campaign information associated with at least the one or more served membership-based ads to a data warehouse;
retrieving transaction information associated with the registered user from the data warehouse;
updating the user profile associated with the registered user based on the retrieved transaction information; and
generating a report based on the user profile regarding at least a transaction completed after viewing at least the one or more served membership-based ads.

16. The computer-readable storage medium of claim 15, wherein the transaction was completed online.

17. The computer-readable storage medium of claim 15, wherein the transaction was completed over the telephone.

18. The computer-readable storage medium of claim 15, wherein the transaction was completed in a retail store.

19. A system for tracking purchases related to digital ads, comprising:
one or more ad providers operative to receive digital ad requests, to determine whether a digital ad will be served to a registered user, to determine whether a membership-based ad is available to serve for the digital ad request in response to determining the digital ad will be served to a registered user; and to serve one or more digital ads to the registered user;
one or more retailers operative to complete a transaction regarding an offer presented to the registered user in the one or more served digital ads; and
one or more data warehouses operative to receive at least ad campaign information associated with at least digital ads served to registered users from the one or more ad providers; to receive transaction data associated with the completed transactions by registered users from the one or more retailers, to provide limited access to the transaction data received from the one or more retailers to at least one of the one or more ad providers; and to provide limited access to at least the ad campaign information received from the one or more ad providers to at least one of the one or more retailers or one or more third party advertisers.

20-21. (canceled)

22. The system of claim 19, wherein at least one of the one or more ad providers comprises a profile management tool operative to allow a user to modify demographic information, behavioral information, and membership-based programs associated with a user profile of the user.

23. The system of claim 191 wherein the one or more retailers are further operative to complete transactions not driven by digital ads and to send transaction data associated with completed transactions not driven by digital ads to the one or more data warehouses.

24. A method for tracking purchases related to digital ads, the method comprising the steps of:
receiving a digital ad request;
determining whether a digital ad will be served to a registered user;
determining whether a membership-based ad is available to serve to the registered user in response to determining the digital ad will be served to a registered user;
serving at least one digital ad to the registered user; and
sending ad campaign information associated with the at least one digital ad to a data warehouse.

25. The method of claim 24, wherein the at least one digital ad comprises at least one membership-based ad.

26. The method of claim 24, further comprising:
detecting a user initiating a transaction is a register user;
completing the initiate transaction; and
sending transaction data associated with the completed transaction to the data warehouse.

27. The method of claim 24, further comprising:
detecting a user initiating a transaction is a registered user;
honoring an offer presented to the registered user in the at least one served digital ad;
completing a transaction regarding the offer presented to the registered user in the at least one digital ad; and
sending transaction data associated with the at least one served digital ad to the data warehouse.

28. A computer-readable medium comprising a set of instructions for tracking purchases related to digital ads, the set of instructions to direct a processor to perform acts of:
receiving a digital ad request;
determining whether a digital ad will be served to a registered user;
determining whether a membership-based ad is available to serve to the registered user in response to determining the digital ad will be served to a registered user;
serving at least one digital ad to the registered user; and
sending ad campaign information associated with the at least one digital ad to a data warehouse.

29. The computer-readable medium of claim 28, wherein the at least one served digital ad comprises at least one membership-based ad.
